(19) United States
(12) Patent Application Publication
(10) Pub. No.: US 2004/0143201 A1
(43) Pub. Date: Jul. 22, 2004

(54) Method of supporting and fastening for effective energy transfer utilizing a vibrating motor for a floor mat application

(76) Inventor: Hiro Moriyasu, Portland, OR (US)

Correspondence Address: DELLETT AND WALTERS, P. O. BOX 2786, PORTLAND, OR, 97208-2786, US

(21) Appl. No.: 10/347,053

(22) Filed: Jan. 17, 2003

(51) Int. Cl. A61H 23/02

(52) U.S. Cl. 601/57; 601/59; 601/70

(57) ABSTRACT

Present invention describes a novel vibrator motor apparatus method of effectively transferring vibrating energy to the user, having supporting structure to prevent vibrating motors from collapsing due to the body weight compressing down against floor. Proposed methods and apparatus overcome limitations of effectively using vibrating motors for low profile floor mat applications.

### BACKGROUND OF THE INVENTION

Traditionally a small dc motor with an eccentric weight is used in various massager machines such as massaging pads, hand held vibrating massage units and vibrating footrests.

The approaches according to prior art, for example, of massaging pads consists of eccentric vibrating motor sandwiched between the top soft foam and the bottom soft foam with a total thickness of 2 to 4 inches and covered with fabric on both sides of the mat. They are used primarily as a chair seat cushion or floor mat in shape of a sleeping bag.

The prior art of sandwiching the vibrating motor between soft foams is satisfactory for massaging pads. However, such an approach has not been successful for the floor mat application. The limitations of such an approach are that the surface is too soft and, when stepped upon, the vibrator is much harder than the covering's soft foam. Therefore, when stepped upon, the unevenness is felt and, if total body weight is applied directly on the vibrating motor, the small dc motor can not over come the force applied and will cease to vibrate.

Even with changing the top and bottom foam to stiffer foam, the problem of withstanding against full body weight remains.

The footrest style massager typically consists of a rotating cam-like mechanism in the shape of a half dome, which rotates or vibrates at/near the top of the platform, protruding up.

The vibrating or rotating mechanism is covered by a fabric. The footrest style massager is not thin enough nor designed to withstand the total body weight exerted directly on the vibrating or rotating mechanism. The small DC operated motor with eccentric weight is well known to be a small and convenient vibrating device to be used in battery or small DC power adaptor units. However, for such a low power unit to be effective in the low profile floor mat application, new methods and approaches particularly applicable to using small low power vibrating motors must be found.

### SUMMARY OF THE INVENTION

The present invention describes a novel vibrator motor apparatus method of effectively transferring vibrating energy to the user, having supporting structure to prevent vibrating motors from collapsing due to the body weight compressing down against floor. Proposed methods and apparatus overcome limitations of effectively using vibrating motors for low profile floor mat applications.

The objective of the present invention is to provide an effective coupling of vibrating energy from a vibrating small DC motor to the user standing on the floor mat.

Another objective of the present invention is to provide various fastening methods for the vibrating motor to withstand the total body weight with minimal loss of vibration when it is being stood upon.

Yet another objective of the present invention is to provide a means to protect the small DC motor from damage caused by heavy objects intruding from the top surface.

Yet another objective is to provide reasonably uniform top surface elastic characteristics to avoid unsafe tripping due to non-uniform surface response when the user walks or steps on it.

Yet another objective of the present invention is to allow vibrating mats to be rolled or folded for ease of carrying or shipping.

Further objective of the present invention is to provide methods to create a greater vibrating therapeutic massaging effect by configuring vibrators to create lower sub harmonic slowly modulating vibration wave-like effects.

Yet a further objective of this invention is to achieve ease and flexibility of assembly and manufacturability of the low profile mat utilizing the vibrating small dc motors.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 illustrates conventional vibrator massager utilizing vibrating motor sandwiched between soft foam.

FIG. 2 illustrates improved method of vibrating motor to create flat top surface and withhold body weight from collapsing vibrating motor.

FIG. 3A thru FIG. 3C illustrated split mounting plate to hold vibrating motor.

FIG. 4A thru FIG. 4C show method of fastening vibrating motor toward top surface.

FIG. 5A through FIG. 5C show bonding method of fastening vibrating motor.

FIG. 6A illustrates two vibrating motor assemble back to back.

FIG. 6B shows end view of FIG. 6A.

FIG. 7 shows multiple vibrating motors individually or back to back to achieve sub harmonic vibrating effect.

### DETAILED DESCRIPTION

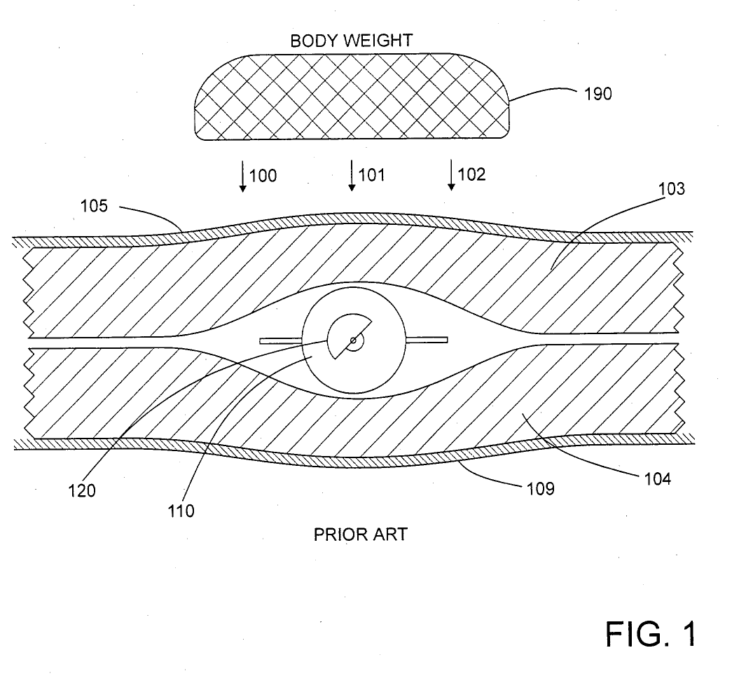

FIG. 1 illustrates a prior art of vibrating vibrator massage pad. The conventional vibrator massager pad utilizing a vibrating motor 110, with eccentric weights 120, sandwiched between soft foams 103, and 104, is shown in the FIG. 1. Soft foams 103, and 104, are covered by fabric-like material 105, and 109. This type of conventional design is desirable for a cushion type pad but not applicable for standing upon. When a vibrating motor pad is stepped on, the motor protrudes and, as the body weight compresses the motor, it essentially ceases the vibration of the motor. The upper illustration in FIG. 1 shows the user's shoes 190, creating a downward force 100, 101, and 102. When the body weight is applied to the top of the vibrating motor, major down word force will be applied directly on the vibrating motor 110.

As it may be seen the vibrator motor 110, being solid it must withstand the majority of the compression force 101, at the bottom center of the user's shoes. Since the foam is soft it will result in very little resistance upward to support countering the down forces 100, and 102.

By using small vibrating motors there will not be sufficient energy to overcome the static body weight of 100 to 250 lbs. When the small vibrating motor is subject to such a high static compression force, vibrator will essentially compress down to the floor thus ceases to vibrate.

Based on vibrating pad in accordance to prior art, encasing the vibrating motor is not well suited for the floor mat applications. Therefore, new methods of vibrating motor support and energy transfer from vibrator motor to the user feet are needed.

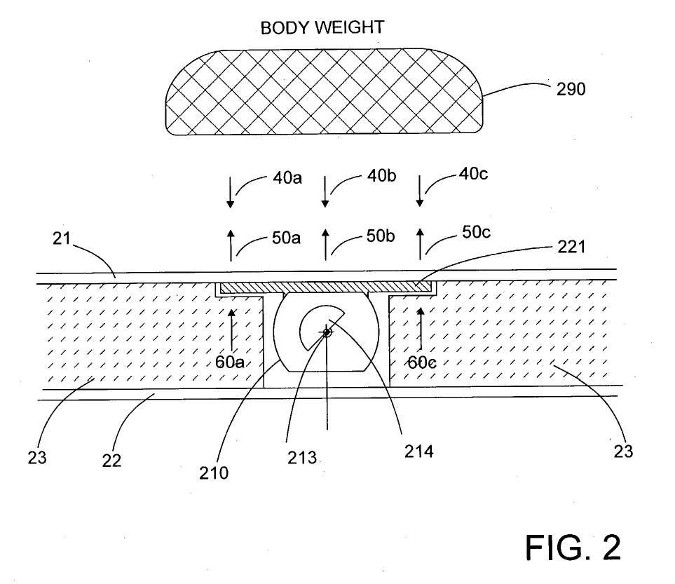

FIG. 2 shows the cross sectional view of an improved method of supporting the vibrating motor to be inserted in the floor mat. Present are the top cover 21, bottom cover 22, inner supporting elastomer 23, and vibrating motor 210, mounted on the semi-flexible flat plate 221. A vibrating motor typically contains an off center weight 214, mounted on the shaft of the dc motor 210. When the mat is stepped on, shoe 290 will apply total body weight on the mat. The inner supporting elastomer 23, is semi-rigid to withstand the body weight but provides some elastomeric comfort thus reducing fatigue.

Three downward arrows representing forces 40a, 40b, and 40c illustrate the distribution of body-weight due to the body weight applied through shoe 290. Reactive forces from the mat below are represented by three arrows 50a, 50b, and 50c.

As it may be seen, the body weight is primarily transferred directly onto the mats by the body weight components 40a, and 40c. Counter reactive forces 50a, and 50c, are supported by the resilience of the inner support elastomer supporting forces of 60a, and 60c, by counteracting body weight exerted by force 40a, and force 40c. It is important to note that because the vibrating motor is being supported at the top flexible plate, the weight of body is not transferred to the vibrating motor 210. Body weight components at the center bottom of the shoe 40b, will contact the mat's top surface directly above the vibrating motor assembly, 210, but there will be no static body weight transferred to the vibrating motor because of the air gap below. In this configuration the vibrating motor is not subject to the body weight. The majority of the vibrating energy in the vertical up-down direction will be transferred to the user's body above.

When power is supplied to the motor, vibrating force 50b, will be transferred to the bottom of the feet through the shoes. The vibrating force 50b, is symbolically shown by up ward arrows. When power is applied to the vibration motor, vibration force of up ward-down ward energy is transferred to the bottom of the shoes. Since the vibrating motor avoids holding up static weight and is relatively free to vibrate, the vibrating energy is more effectively transmitted to the person standing on it. Previously known limitations of using a smaller DC motor to achieve the low profile did not provide sufficient power. Increasing power to withstand weight in the range of 200 pounds means larger motors and higher profile as seen on footrest vibrators. Proposed method according to the present invention method of supporting close to the top surface of mat and avoiding static body weight overcomes previous limitations of using small DC vibrator motor in low profile floor mats, and withstands heavy weight loads.

Although FIG. 2 is illustrated with an air gap below the motor, anti-noise foam (not shown) may be placed below the motor preventing clanking noise. When unusually heavy load is applied, the vibrating motor comes close to bottom cover—soft foam reduces the impact noise.

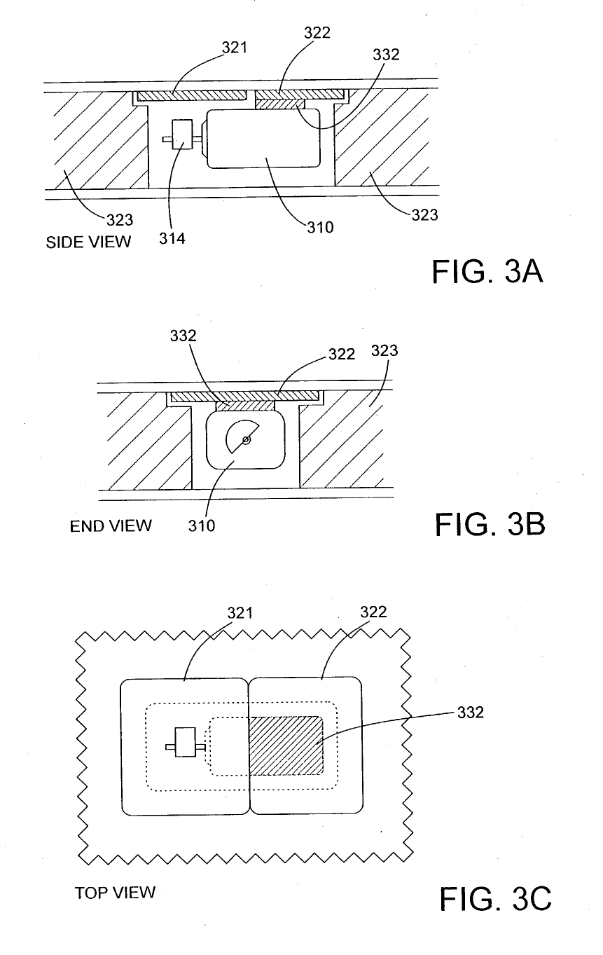

FIG. 3A shows two top plates. Plate 321, is a cover plate attached to the inner support elastomer 323, but not the attached to the motor. The vibrating motor 310, is attached to the plate 322, and fastened or bonded 332, to the plate 322.

When power is applied to the DC motor the vibrating force is caused by the unbalanced weight 314, and the vibrating energy is transmitted through the back end of the motor to the partial top plate 322. The rotational vibration will take place pivoting around the rear fastening or bounding media 332. This creates a lever action vibrating action to amplify the vibrating force to the upper surface. Having semi-flexible top rear plate alone with inner layer support elastomer 323, will create resonating motion of vibrating motor 310, further achieving a greater vibration amplification effect is achieved with relatively small vibrating motor while withstanding a heavy body weight imposed from above and allowing relative low profile construction.

FIG. 3B shows the end view of the vibrating motor split support plates.

FIG. 3C shows top view of split support plates. Left side plate 321, placed to cover vibrating motor. Right side top plate 322, is attached to the motor below to provide protection to motor from body load and provide vibrating energy transfer to the bottom of the feet.

Using conventional methods of support, such an effect is suppressed by the body weight. Novel methods of supporting and transferring the vibrating energy effectively to the user overcomes the conventional approach.

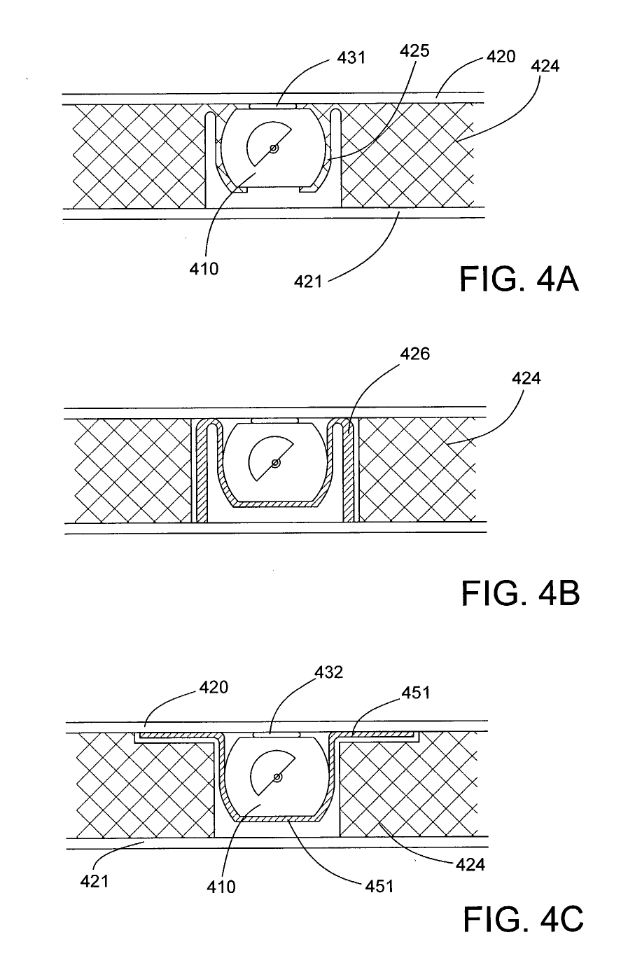

FIG. 4A illustrates a method of supporting and fastening the vibration motor 410, with very close proximity, to the top cover 420, in order to maximize energy transfer while avoiding static weight. Vibrating motor 410, is fastened by the support 425, which may be a part of the support elastomer 424. To maintain a close proximity to the top surface, the vibrating motor may be bonded 431, to the top cover 420. In this configuration the bottom side the vibrating motor is not in contact with the bottom cover and does not handle static body weight of user standing on it.

FIG. 4B illustrates that the vibrator support 426, may be constructed as a mounting frame motor to provide some protection and allow assembly convenience. Then the motor and frame can insert inside of the mat inner support elastomer 424, as an assembly.

FIG. 4C illustrates another embodiment of the present invention to allow vibrating motor 410, to transfer majority of the vibrating energy to the user above using flexible motor hanging strap 451, to keep bottom of the bottom cover 421. The vibrating motor 410, may be bonded 432, to the top cover 420, and without being restrained by the body weight and minimizing the vibrating energy loss to the floor below.

Vibrating inner motor 410, is supported in contact to top cover 420, by a support strap 451, and/or bonding, 432. The strap is also attached to the supporting elastomer 424, and/or top cover 420.

Supporting strap 451, may be a semi-flexible elastomers, a flexible perforated plastic, or mesh-like strap.

As it is evident by those skilled in the art, many variations are possible to support a vibrating motor in close proximity to the top surface and/or sides while avoiding static body weight. This may include the use of a frame-like structure. All such variations are covered by scope and spirit of the present invention.

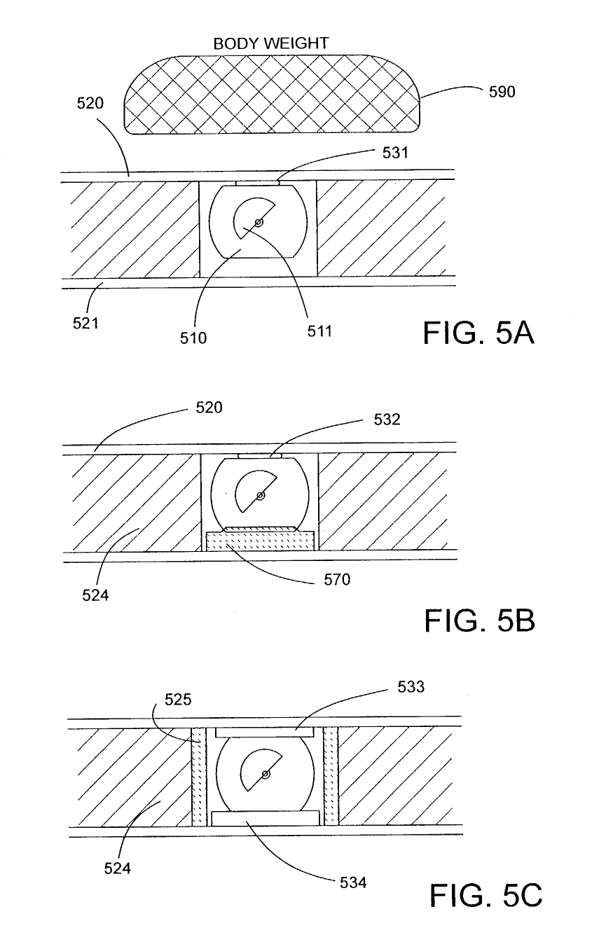

FIG. 5A shows direct bonding 531, of the vibrator motor 510, to the top cover 520. In this configuration bonding or fastening material 531, bonds the vibrator motor 510. The bonding material 531, may consist of semi-flexible bonding elastomer or thin elastic foam with flexible permanent bond to ensure maximum energy transfer to the top surface.

There is a very important advantage of fastening or bonding the vibrating motor more directly below the top map cover.

In this configuration, the bonded area becomes, in effect, a pivot point of pendulum-like vibrating motor.

When the vibrator motor vibrates eccentrically but fastened at the top, it creates an up-down vibration and rocking (or rotating back-and-forth respect to bonded areas) vibration at the area of fastened point. The rocking vibration adds even greater vibration amplification force due to lever-like action. Furthermore, rocking vibration action vibration does not have to withstand direct body weight 590. It can transmit rocking vibration in a much more effective manner in spite of using a smaller DC motor to reduce height restriction.

FIG. 5B shows a soft elastomer foam 570, added to further assure that the vibrating motor will float above and against the top cover while allowing downward displacement of vibrator motor 510. The purpose of the bottom soft foam is not intended to support body weight—rather to assure vibrator to float up against the top cover—it still allows some downward displacement of the top mat cover and the motor. Furthermore, the bottom elastomer will deaden the vibrating chattering noise in event of an extraordinary concentrated weight loading and depressing above the vibrating motor.

FIG. 5C illustrates additional frame structure 525, surrounding the vibrator motor. The characteristic support frame 525, having stiffer elastomeric properties than that of inner support elastomer 524, will further assure body weight compressing down from the above the mat will not collapse vibrating motor to the bottom cover and the floor. Such a protective supporting frame, surrounding all side of the vibrating motor may be placed within any configuration such as FIG. 5A or FIG. 5B.

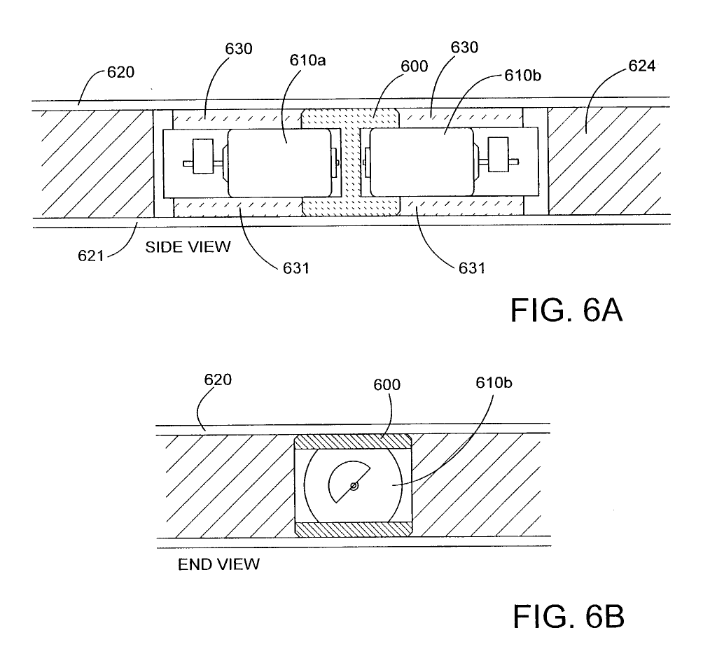

FIG. 6A illustrates dual vibrating motors 610a, and 610b, connected back to back with a semi rigid coupling structure and stand off 600. Assembly is inserted inside of the supporting elastomer 624, and covered by top cover 620, and bottom cover 621. The void created between the vibrators 610a, and 610b, and the top cover 620, and bottom cover 621, may be filled with soft foam to reduce rattling 630, and 631.

The vibrating motor 610a, and 610b, with eccentric weight creating unbalanced centrifugal forces in all directions. These unbalanced vibrations are supported by coupling and stand off structure at rear ends of the vibrating motor. These vibrating eccentric forces will be coupled to the top surface cover pivoting on the bottom side of the support stand off 600. This will create forces multiplying leverage to the body above while withstanding to the static body weight above. It is appreciated by those skilled in the art that variations of support and coupling create leverage or torque leverage to create a rocking action. Such variations are covered in the scope and spirit of present invention. This approach may be used singly or as multiple vibrator configurations.

It may be noted coupling structure 600, can act as weight support standoff to withstand central force directly applied above the dual vibrators motor above. More importantly, the purpose is to create a stronger vibrating force due to the lever action of the two motors witch pivot around the center.

FIG. 6B shows an end view of the dual vibrator motor.

It is noteworthy to point out that two or more vibrating motors may be joined or placed in close proximity to create additional vibrating patterns. For example, crosswise connection of four vibrating motors connected to perform even circularly modulating sub harmonic vibrating massage action to create soothing sensation to the user standing on it.

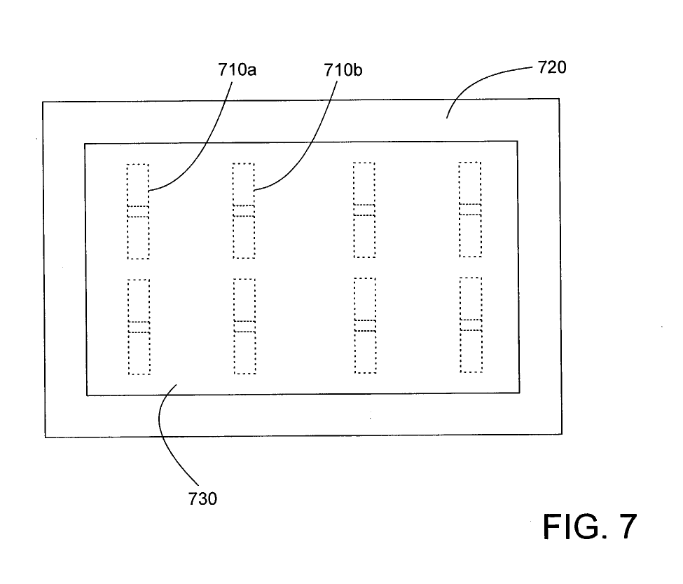

FIG. 7 illustrated the top view example of vibrating motors or vibrating motor assembly 710a, and 710b. Inner supporting structure (not shown) will be inserted between top cover 730, and bottom cover 720. The edges of the mats may be tapered to reduce user from tripping. The inner support structure will have cut out space to accommodate motor assembly.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. Vibrating motor apparatus and methods to effectively transfer energy to the user standing on the vibrating mat without being restrained by user's body weight, comprising:
a vibrating motor having eccentric weights;
a supporting means that substantially places vibrator motor close proximity to the upper covering material to assure adequate space below the vibrating motor such that the bottom of vibrating motor will not be compressed against the bottom cover and floor below,
a semi-rigid inner support elastomer having cut out space for the vibrating motor assembly that acts as a protecting structure surrounding the vibrating motor,
a top and bottom protective cover.

2. A vibrating motor apparatus and methods according to claim 1, further comprising a flexible supporting plate to hold a vibrator motor below and placed above the inner supporting elastomer to substantially support the body weight.

3. A vibrating motor apparatus and methods according to claim 2, further comprising split upper supporting plates where one plate is bonded or fastened to the vibrating motor.

4. A vibrating motor apparatus and methods according to claim 1, further comprising a flexible supporting means to embrace, strap, and encase vibrating motor while vibrating motor is supported flexibly at the top surface of supporting structure or semi flexible frame-like structure.

5. A vibrating motor apparatus and methods according to claim 1, further comprising of bonding or flexible adhering to the top cover thus creating an air gap or space below the vibrating motor below to accommodate depression of the body weight such that the vibrating motor will not be totally compressed to the bottom.

6. A vibrating motor apparatus and methods according to claim 5, further comprising of soft floating foam below the vibrating motor to assure vibrating motor floats up close to the top corner to ensure maximum energy transfer and minimizing the noise created if and when bottom of vibrating motor is close to touching the bottom cover and floor.

7. A vibrating motor apparatus and methods according to claim 6, further comprising thin foam-like material placed or adhered above vibrating motor and below the top cover.

8. A vibrating motor apparatus and methods according to claim 1, further comprising at least two vibrating motors;
a coupling means to connect two or more motors back to back the create sub harmonic modulating vibrating action to allow additional effects when used in the floor mat or pad like application.

9. A vibrating motor apparatus and methods according to claim 1, further comprising of semi-rigid frame-like structure surrounding the vibrator motor assembly and having a higher rigidity than the surrounding supporting material to protect.
